(19) United States
(12) Patent Application Publication
(10) Pub. No.: US 2006/0033286 A1
(43) Pub. Date: Feb. 16, 2006

(54) Graphite loaded PTFE mechanical seals for rotating shafts

(75) Inventor: David A. Erich, St. Mary's, PA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CoorsTek, Inc., Golden, CO (US)

(21) Appl. No.: 10/903,510

(22) Filed: Jul. 29, 2004

(51) Int. Cl. F16J 15/34

(52) U.S. Cl. 277/358

(57) ABSTRACT

A mechanical seal surrounding a rotary shaft to prevent a fluid (i.e., a liquid or gas) from flowing across the seal, the seal including a rotatable seal ring that includes a rotatable seal face, where the rotatable seal ring is rotatable around a rotational axis of the rotary shaft, and a stationary seal ring spatially fixed relative to the rotatable seal ring and having a stationary seal face to engage the rotatable seal face to form the mechanical seal, where the stationary seal ring includes about 1% to about 30%, by weight, graphite, and about 70% to about 98%, by weight, polytetrafluoroethylene. Also, a graphite containing teflon sealing ring used to form a mechanical seal around a rotary shaft, where the teflon sealing ring includes a first seal face capable of engaging a second seal face on a second sealing ring surrounding the rotary shaft to form the mechanical seal. The teflon sealing ring may include graphite, polytetrafluoroethylene, and optionally, non-graphite carbon.

### BACKGROUND OF THE INVENTION

This invention relates generally to mechanical seals for rotating shaft machinery. Specifically, the invention includes the use of graphite containing polytetrafluoroethylene sealing elements to form seals around a rotatable shaft.

Mechanical seals may be used to prevent fluids (e.g., hydrocarbon gases, water) from escaping a confined space by flowing around rotating shaft machinery extending into that space from outside. These seals have application in a wide variety of devices and processes where such machinery is used, including dishwashers, washing machines, mixers, pumps, and many other kinds of machinery.

In early applications, it was common to make mechanical seals from cloth or rope wedged between the rotating shaft and the fluid containment wall. Later seal designs replaced cloth and rope with elastomeric materials (e.g., O-rings) clamped or stretched around the rotating shaft. While these rotating seals are simple to implement, they have relatively short lifetimes due to wear at the sealing interface, heat damage from friction, and damage from corrosive fluids absorbing into the sealing materials. In addition, when these materials slip around the rotating shaft, they may wear away protective films (e.g., a protective oxide film) formed on the surface of the shaft, allowing corrosive fluids to corrode away the underlying shaft material and further weaken the seal.

Later seal designs included mechanical seals that had a seal interface formed between two seal rings, one of which may rotate with the rotating shaft while the other remains fixed. The rings, which may be coaxial to the rotational axis of the shaft, have opposite facing sealing faces that form a fluid seal by making contact with each other. The materials used to make the seal rings may be chosen to minimize the effects of friction and wear at the contacting sealing faces.

A conventional mechanical seal ring design includes forming the stationary seal ring out of a hard material (e.g., silicon carbide (SiC)) and the rotating seal ring out of graphite containing carbon. The planar grain structure of graphite makes it a natural lubricant for the sealing interface, and its thermal conductivity provides for the fast dissipation of the frictional heat generated as the rotational seal ring rotates against the stationary ring. Unfortunately, production of the graphite containing carbon rings is time consuming and expensive.

Typically, the process starts by mixing graphite and carbon particulates with an organic binder material (i.e., glue) and baking the mixture in an oven. Because the goal of the baking is to decompose the binder into carbon without forming CO and/or CO₂, the mixture needs to bake very slowly (e.g., about 30 to 60 days depending on the materials) at temperatures of 500° C. or more. Furthermore, the oven has to be purged of ambient air to prevent the oxygen in the air from reacting with carbon in the baking sealing ring. Thus, there remains a need for materials that can be used in the sealing rings of mechanical seals that do not require the time and energy intensive production steps of graphite containing carbon.

### BRIEF SUMMARY OF THE INVENTION

Embodiments of the invention include a mechanical seal surrounding a rotary shaft to prevent a fluid (i.e., a liquid or gas) from flowing across the seal. The seal may include a rotatable seal ring that includes a rotatable seal face, where the rotatable seal ring is rotatable around a rotational axis of the rotary shaft. The seal may also include a stationary seal ring spatially fixed relative to the rotatable seal ring and having a stationary seal face to engage the rotatable seal face to form the mechanical seal. The stationary seal ring may be made from about 1% to about 30% (by weight) graphite, and about 70% to about 98% (by weight) polytetrafluoroethylene. The seal ring may also optionally include about 1% to about 30% (by weight) non-graphite carbon.

Embodiments of the invention also include a mechanical seal surrounding a rotary shaft to prevent a fluid from flowing across the seal. The seal may include a stationary seal ring that includes a stationary seal face, where the stationary seal ring is positioned around the rotary shaft. The seal may also include a rotatable seal ring that is rotatable relative to the stationary seal ring and has a rotatable seal face to engage the stationary seal face to form the mechanical seal. The rotatable seal ring may be made from about 1% to about 30% (by weight) graphite, and about 70% to about 98% (by weight) polytetrafluoroethylene. The seal ring may also optionally include about 1% to about 30% (by weight) non-graphite carbon.

Embodiments of the invention may also include a graphite containing teflon sealing ring used to form a mechanical seal around a rotary shaft. The teflon sealing ring may include a first seal face capable of engaging a second seal face on a second sealing ring surrounding the rotary shaft to form the mechanical seal. The teflon sealing ring may be made from about 1% to about 30% (by weight) graphite, and about 70% to about 98% (by weight) polytetrafluoroethylene. The seal ring may also optionally include about 1% to about 30% (by weight) non-graphite carbon.

Additional features are set forth in part in the description that follows, and in part will become apparent to those skilled in the art upon examination of the following specification or may be learned by the practice of the invention. The features and advantages of the invention may be realized and attained by means of the instrumentalities, combinations, and methods particularly pointed out in the appended claims.

### BRIEF DESCRIPTION OF THE DRAWINGS

FIG. 1 shows a simplified sectional view of a mechanical seal assembly according to embodiments of the invention;

FIG. 2 shows a simplified sectional view of another mechanical seal assembly according to embodiments of the invention; and

FIG. 3 shows a flowchart of the process steps for making a sealing ring according to an embodiment of the invention.

### DETAILED DESCRIPTION OF THE INVENTION

The present invention includes mechanical seals that include sealing rings made from graphite loaded tetrafluoroethylene (PTFE). As noted above, the graphite provides a natural lubricant for the sealing interface, and its thermal conductivity provides for the fast dissipation of the frictional heat. However, the graphite loaded PTFE rings of the present invention do not require complex, time consuming and energy intensive production processes, and therefore may be made at a significantly reduced cost. Moreover, the higher oxidation and corrosion resistance of PTFE make graphite loaded PTFE sealing rings suitable for mechanical seals exposed to a wide variety of chemical environments.

Exemplary Mechanical Seal Assembly

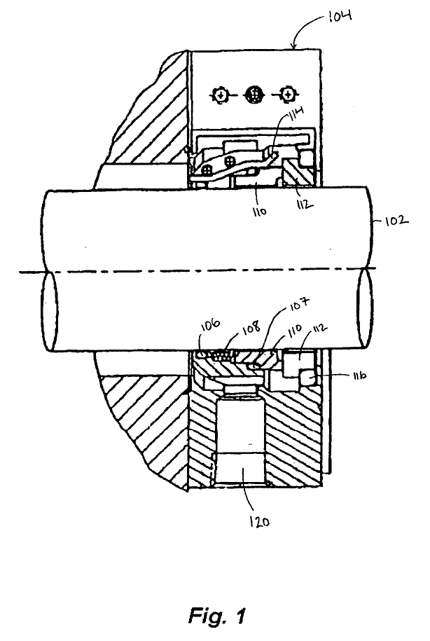

Referring now to FIG. 1, a sectional view of a mechanical seal assembly 100 according to embodiments of the invention is shown. The assembly 100 may be used to form a seal around rotatable shaft 102 through the engagement of opposing sealing faces on rotatable seal ring 110 and stationary seal ring 112. The seal rings 110 and 112 may be part of a seal flange 104 that separates a sealed fluid side from an opposite side (e.g., a non-sealed side, a shaft motor side, etc.).

In some embodiments, the rotatable seal ring 110 and shaft 102 may be separated by a gap that keeps the two components from making direct physical contact. This gap may be maintained by o-ring 106 that helps keep shaft 102 aligned with seal flange 104. O-ring 106 may physically contact both the shaft 102 and gland gasket 114 in seal flange 104, and may help prevent fluid from leaking across the surface of shaft 102. The o-ring 106 may rotate with shaft 102 and make rotational contact with gasket 114. Another o-ring 107 may be placed around rotatable seal ring 110 to help maintain the ring 110 in position around shaft 102. O-ring 107 may rotate with rotatable seal ring 110 and may make rotatable contact with gasket 114.

Engagement of the opposing sealing faces on rotatable seal ring 110 and stationary seal ring 112 may be assisted by spring 108 urging the rotatable seal ring 110 towards the stationary seal ring 112. While rotatable seal ring 110 may be urged towards stationary seal ring 112, the stationary seal ring 112 may be prevented from moving away from the rotatable seal ring 110 by boot 116.

Either the rotatable seal ring 110 or stationary seal ring 112 may include graphite loaded PTFE. The graphite loaded PTFE may also optionally include carbon (e.g., about 1% to about 30%, by weigh, non-graphite carbon). When one of the seal rings 110 or 112 includes graphite loaded PTFE, the other ring may include harder materials, such as alumina (Al₂O₃), silicon carbide (SiC), diamond (C), steel, stellites (i.e., alloys of cobalt with varying amounts of chromium, nickel, iron, tungsten, and/or silicon) and/or tungsten carbide (WC, W₂C), among other materials.

In some embodiments, seal rings 110 and 112 engage each other with physical contact at the sealing faces on each ring. The contact may cause the graphite in the graphite loaded PTFE to be deposited in a layer at the interface of the sealing faces that helps form the mechanical seal between the sealing rings 110 and 112. In additional embodiments, there may not be physical contact between the sealing rings 110 and 112 when they engage one another to form the mechanical seal. In these non-contacting sealing embodiments, one of the sealing rings may have groves, trench patterns, etc. etched into the sealing face that helps create the mechanical seal through fluid dynamics effects occurring in the gap between the sealing rings 110 and 112.

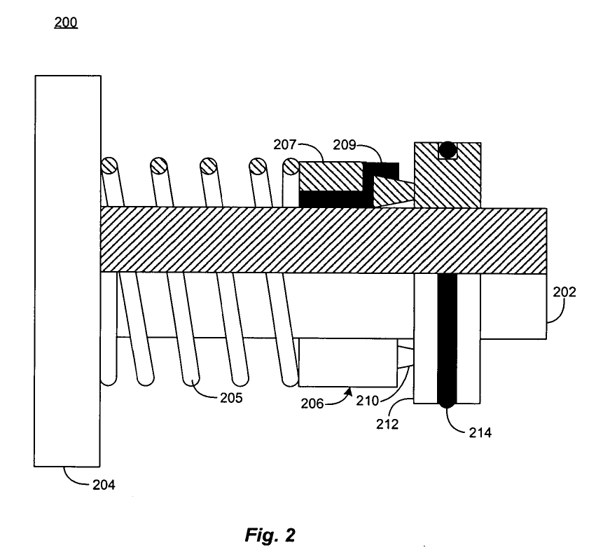

FIG. 2 shows a sectional view of another mechanical seal assembly 200 according to embodiments of the invention. Assembly 200 may be used to form a seal around rotatable shaft 202 through the engagement of opposing sealing faces on rotatable seal ring 210 and stationary seal ring 212. A groove may be formed in an edge of the stationary seal ring 212 to holding o-ring 214 in place around the circumference of the seal ring 212. O-ring 214 may sealingly engage a portion of the shaft housing (not shown) to prevent fluid, particulates, etc., from passing over the seal ring 212 and escaping out the end of shaft 202. The material used in o-ring 214 may depend on materials and operating environment for assembly 200. O-ring materials may include, for example, natural and synthetic rubbers.

The rotatable seal ring 210 may be part of a rotatable seal assembly 206 that also includes external housing 207 and shaft elastomer 209 for rotatably coupling the ring assembly 206 to the shaft 202. The rotatable seal assembly 206 may be urged into engagement with the stationary seal ring 212 with the aid of spring 205. Spring 205 may be set to a steady pressure (e.g., at least 4 psi) at the interface of the sealing rings that helps form the mechanical seal. Seal flange 204 may act as a stop for an end of spring 205 that is opposite the end engaging rotatable seal assembly 206.

Similar to the embodiments described in FIG. 1, either the rotatable seal ring 210 or the stationary seal ring 212 may be made from graphite loaded PTFE. The seal ring may also include carbon fibers. When one seal ring is made from graphite loaded PTFE, the other may be made from harder materials, such as alumina, silicon carbide, diamond, steel, stellites, tungsten carbide, etc. The mechanical seal between seal rings 210 and 212 may be formed through a contacting or non-contacting seal interface.

The mechanical seals shown in FIGS. 1 and 2 may be used in a variety of applications, including re-circulation/boiler feed pumps, sump pumps, sewage pumps, wastewater pumps, irrigation pumps, food and beverage pumps, drainage pumps, chemical pumps, well pumps, compressors, pool pumps, spa pumps, jetted tub pumps, grinder pumps, and hydraulic pumps, among other applications. As noted above, the mechanical seals may also be used in a number of appliances, including dishwashers, washing machines, etc.

Exemplary Method of Forming PTFE Seal Ring

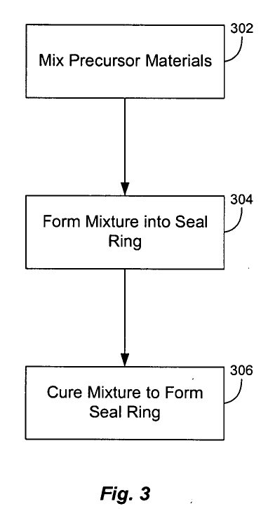

FIG. 3 shows a flowchart that includes steps for forming a graphite loaded PTFE seal ring according to embodiments of the invention. The process includes mixing together precursor materials 302 that may include powders of synthetic graphite (e.g., about 1% to about 30%, by weigh) with a PTFE resin (e.g., about 70% to about 98%, by weight). In some embodiments, non-graphite carbon (e.g., about 1% to about 30%, by weight) may also be added to the mixture. The non-graphite carbon may include any form of carbon other than graphite, such as coal particulates, soots, and carbon black, as well as covalent network solid forms of carbon such as diamond and diamond-like carbon. The non-graphite carbon may include substantially rounded carbon particulates and/or carbon fibers.

The base resin of PTFE may be mixed with a predetermined weigh percentage of graphite and carbon to produce a mixture with about 5% to about 30% (by wt.) graphite in PTFE. Examples of mixtures include about 5% (by wt.) graphite in PTFE, about 10% (by wt.) graphite in PTFE, about 15% (by wt.) graphite in PTFE, and about 27% (by wt.) graphite with about 3% (by wt.) non-graphite carbon in PTFE, among other mixtures.

The mixture may be formed into a seal ring 304 by pouring the mixture into a mold having the shape of the seal ring. For example, the mixture may be poured into a compression mold where the sealing ring is formed under a predetermined amount of pressure. The uncured sealing ring may then be placed into a furnace a cured 306 using a multi-stage heating process to form the graphite loaded PTFE sealing ring. For example, heating process may start out at room temperature and then be ramped up to about 550° F. over the course of 4 hours. The ring is then held at 550° F. for about 1 hour before the temperature is increased further to about 700° F., over the course of a few hours (e.g., 3 hours) and held at the higher temperature for a few more hours (e.g., 3 hours). Then the ring may be cooled from 700° F. to 500° F. over a period of 4.5 hours, and held at 500° F. for another hour. Finally, the ring may be cooled from 500° F. to about 80° F. over the course of about 4 hours, before being removed from the furnace.

### EXAMPLES

The wear characteristics of mechanical seals using graphite loaded PTFE seal rings according to embodiments of the invention were tested for 50 hours and 250 hours of continuous operation. The mechanical seals were formed by a sealing face of a rotary sealing ring made from 5%, by wt., graphite in polytetrafluoroethylene that engaged an opposite sealing face on a stationary seal ring made from 99.5% alumina (AD995).

The rotary sealing ring was placed on a 0.5 inch diameter shaft that was set to rotate at 1750 rpm while engaging the stationary sealing ring. The sealing faces on the seal rings were pressed together at contact pressures ranging between 4 to 5.5 psi to ensure that the sealing faces maintain a mechanical seal throughout the test. All tests were performed in an ambient environment at a temperature of about 19° C. After a preset number of hours of continuous operation (i.e., 50 hours or 250 hours) the rotating shaft was stopped and the length of rotary seal ring was measured to determine the extent that material had been worn off the ring. Table 1 lists the wear measurement results for three 5% graphite PTFE rotary seal rings after 50 hours of continuous operation, and a fourth 5% graphite PTFE rotary seal ring after 250 hours of operation.

TABLE 1
Mechanical Seal Wear Test Results

| Test Conditions | Test 1 | Test 2 | Test 3 | Test 4 |
|---|---|---|---|---|
| Test Duration | 50 hours | 50 hours | 50 hours | 250 hours |
| Shaft Speed | 1750 rpm | 1750 rpm | 1750 rpm | 1750 rpm |
| Contact Pressure | 5.238 psi | 5.267 psi | 5.121 psi | 4.191 psi |
| Environment Temp | 19° C. | 19° C. | 19° C. | 19° C. |
| Rotary Seal Ring | 5% Gr PTFE | 5% Gr PTFE | 5% Gr PTFE | 5% Gr PTFE |
| Rotary Seal Ring Thickness | 0.2510 inches | 0.2490 inches | 0.2495 inches | 0.2490 inches |
| Stationary Seal Ring | AD995 | AD995 | AD995 | AD995 |
| Test Results | | | | |
| Rotary Seal Ring Wear | 0.0020 inches | 0.0005 inches | 0.0015 inches | 0.0015 inches |
| Stationary Seal Ring Wear | 0.0000 inches | 0.0000 inches | 0.0000 inches | 0.0000 inches |
| Temperature Generation | 3° C. | 3° C. | 6° C. | 3° C. |
| Coefficient of Friction | 0.04 | 0.04 | 0.04 | 0.03 |

The test results in Table 1 show that the 5% graphite PTFE rotary seal ring used in the mechanical seals consistently showed little wear after 50 hours of continuous operation, only losing between 0.5 and 2 mils (i.e., thousands of an inch) of material from a quarter inch thick seal ring. The longevity of the low wear properties was confirmed in the 250 hour test (i.e., Test #4) which measured a loss of only 1.5 mils of material from the quarter inch, 5% graphite PTFE, rotary seal ring.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. Accordingly, the above description should not be taken as limiting the scope of the invention.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups.

What is claimed is:

1. A mechanical seal surrounding a rotary shaft to prevent a fluid from flowing across the seal, the seal comprising:
a rotatable seal ring comprising a rotatable seal face, wherein the rotatable seal ring is rotatable around a rotational axis of the rotary shaft;
a stationary seal ring spatially fixed relative to the rotatable seal ring and having a stationary seal face to engage the rotatable seal face to form the mechanical seal, wherein the stationary seal ring comprises:
about 1% to about 30%, by weight, graphite; and
about 70% to about 98%, by weight, polytetrafluoroethylene.

2. The mechanical seal of claim 1, wherein the stationary seal ring comprises about 1% to about 30%, by weight, of non-graphite carbon.

3. The mechanical seal of claim 2, wherein the stationary seal ring comprises about 3%, by weight, of the non-graphite carbon.

4. The mechanical seal of claim 1, wherein the stationary seal ring comprises about 5% to about 27% graphite.

5. The mechanical seal of claim 1, wherein the stationary seal ring comprises about 70% polytetrafluoroethylene.

6. The mechanical seal of claim 1, wherein the stationary seal face engages the rotatable seal face with a fluid that fills a gap between the two faces.

7. The mechanical seal of claim 6, wherein the fluid is air.

8. The mechanical seal of claim 6, wherein the rotatable seal face comprises a plurality of grooves formed in the seal face to conduct the fluid into the gap.

9. The mechanical seal of claim 1, wherein the rotatable seal ring comprises alumina, silicon carbide, or tungsten carbide.

10. The mechanical seal of claim 1, wherein a portion of the graphite from the stationary seal ring is deposited on the rotatable seal ring to form a graphite layer that is in contact with both the stationary seal face and the rotatable seal face.

11. The mechanical seal of clam 1, wherein the rotary shaft rotates at a rate of about 1750 rpm.

12. The mechanical seal of claim 1, wherein the seal comprises a gap between an inner diameter of the stationary seal ring and the rotary shaft.

13. The mechanical seal of claim 12, wherein an o-ring is positioned in the gap between the inner diameter of the stationary seal ring and the rotary shaft.

14. The mechanical seal of claim 1, wherein the seal comprises an elastic member circularly engaging the stationary seal ring to press the seal ring against the rotary shaft.

15. The mechanical seal of claim 14, wherein the elastic member is an o-ring or spring.

16. The mechanical seal of claim 1, comprising a compressive member coupled to the stationary seal ring to press the stationary seal face against the rotatable seal face.

17. The mechanical seal of claim 1, wherein the fluid is a gaseous hydrocarbon or water.

18. The mechanical seal of claim 1, wherein the seal is used in a dishwasher or a washing machine.

19. A mechanical seal surrounding a rotary shaft to prevent a fluid from flowing across the seal, the seal comprising:
a stationary seal ring comprising a stationary seal face, wherein the stationary seal ring is positioned around the rotary shaft;
a rotatable seal ring that is rotatable relative to the stationary seal ring and having a rotatable seal face to engage the stationary seal face to form the mechanical seal, wherein the rotatable seal ring comprises:
about 1% to about 30%, by weight, graphite; and
about 70% to about 98%, by weight, polytetrafluoroethylene.

20. The mechanical seal of claim 19, wherein the rotatable seal ring comprises about 1% to about 30%, by weight, of non-graphite carbon.

21. The mechanical seal of claim 19, wherein the rotatable seal ring comprises about 3%, by weight, of the non-graphite carbon.

22. The mechanical seal of claim 19, wherein the rotatable seal ring comprises about 5% to about 27% graphite.

23. The mechanical seal of claim 19, wherein the rotatable seal ring comprises about 70% polytetrafluoroethylene.

24. The mechanical seal of claim 19, wherein the stationary seal ring comprises alumina, silicon carbide, tungsten carbide, steel, or stellites.

25. A graphite containing teflon sealing ring used to form a mechanical seal around a rotary shaft, wherein the teflon sealing ring comprises a first seal face capable of engaging a second seal face on a second sealing ring surrounding the rotary shaft to form the mechanical seal, and wherein the teflon sealing ring comprises:
about 1% to about 30%, by weight, graphite; and
about 70% to about 98%, by weight, polytetrafluoroethylene.

26. The graphite containing teflon sealing ring of claim 25, wherein the teflon sealing ring comprises about 1% to about 30%, by weight, non-graphite carbon.

27. The graphite containing teflon sealing ring of claim 25, wherein the teflon sealing ring is stationary relative to the second sealing ring.

28. The graphite containing teflon sealing ring of claim 25, wherein the rotatable seal ring comprises about 3% of the non-graphite carbon.

29. The graphite containing teflon sealing ring of claim 25, wherein the rotatable seal ring comprises about 5% to about 27% graphite.

30. The graphite containing teflon sealing ring of claim 25, wherein the rotatable seal ring comprises about 70% polytetrafluoroethylene.

31. The graphite containing teflon sealing ring of claim 25, wherein the second sealing ring comprises alumina, silicon carbide, or tungsten carbide.
